(19) United States
(12) Patent Application Publication
(10) Pub. No.: US 2019/0303595 A1
(43) Pub. Date: Oct. 3, 2019

(54) METHOD AND APPARATUS FOR MANAGING DATABASE AND NON-TRANSITORY STORAGE MEDIUM

(71) Applicant: MIROKU JYOHO SERVICE CO., LTD., Tokyo (JP)

(72) Inventor: Hiroshi KOSAKA, Tokyo (JP)

(73) Assignee: MIROKU JYOHO SERVICE CO., LTD., Tokyo (JP)

(21) Appl. No.: 16/443,888

(22) Filed: Jun. 18, 2019

Related U.S. Application Data
(63) Continuation of application No. PCT/JP2017/045566, filed on Dec. 19, 2017.

(30) Foreign Application Priority Data
Dec. 20, 2016 (JP) 2016-246211

(51) Int. Cl. G06F 21/62; G06F 16/21

(52) U.S. Cl. CPC G06F 21/62; G06F 16/21

(57) ABSTRACT

A common program causes a server to function as an identification information registration unit that stores a user identification in association with a verification identification different from the user identification when an individual program newly stores the user identification in a database that stores information of users, an acquisition unit that acquires the verification identification associated with the user identification when an individual program requests a connection to the database based on the user identification, an addition unit that adds information including the user identification after assigning the verification identification acquired by the acquisition unit when the individual program adds the information to the database, and a manipulation unit that manipulates information including the user identification stored in the database on the basis of the verification identification acquired by the acquisition unit and the verification identification associated with the information when the individual program manipulates the information.

### CROSS-REFERENCE TO RELATED APPLICATIONS

The present application is a continuation application of International Application number PCT/JP2017/045566, filed on Dec. 19, 2017, which claims priority under 35 U.S.C § 119(a) to Japanese Patent Application No. 2016-246211, filed on Dec. 20, 2016. The contents of this application are incorporated herein by reference in their entirety.

### BACKGROUND

The present disclosure relates to a non-transitory storage medium storing a common program, a database management apparatus, and a database management method. Recently, with the development of virtualization technology, data of a plurality of users is managed with a single database (known as multitenancy) (for example, see Japanese Unexamined Patent Application Publication No. 2013-088830). When data of the plurality of users is managed with the single database, user identification information for identifying a user should be contained in each table in the database. Then, on the basis of the user identification information corresponding to a user who logged in, information of the user is extracted from the database.

There is a problem that information of other users would be manipulated when there is a failure in a program for manipulating information contained in the database for multitenancy. For example, when extracting a piece of information that includes user identification information corresponding to a predetermined user, an extraction condition of matching the user identification information with the user identification information corresponding to the predetermined user should be specified, but there may be a case where a failure is included in the program such that different information would be specified as the extraction condition. In this case, information that does not include the user identification information corresponding to the predetermined user, that is to say information of other users, would be extracted. For this reason, it is desired not to manipulate information of other users even if a failure is included in a program.

### SUMMARY

The present disclosure provides a non-transitory storage medium storing a common program, a database management apparatus, and a database management method that can prevent manipulating other user's information.

The database management method, executed by a processor, according to the first embodiment of the present disclosure includes steps of: storing user identification information for identifying a plurality of users in association with verification identification information when the user identification information is newly stored in a database in which information of the plurality of users is stored, the verification identification information being used for identifying the users and different from the user identification information, by executing any of a plurality of individual programs; acquiring, from the database, the verification identification information associated with the user identification information when the processor requests a connection to the database based on the user identification information by executing any of the plurality of individual programs; adding the verification identification information to a record including the user identification information after assigning the verification identification information to the record when the processor adds the record including the user identification information to the database by executing any of the plurality of individual programs after being connected to the database based on the user identification information; and manipulating the record including the user identification information stored in the database on the basis of (i) the verification identification information acquired from the database and (ii) the verification identification information associated with the record including the user identification information in the database when the processor manipulates the record including the user identification information stored in the database by executing any of the plurality of individual programs after being connected to the database based on the user identification information.

The database management apparatus according to the second embodiment of the present disclosure includes a storage medium storing a database; and a processor, wherein the processor stores user identification information for identifying a plurality of users in association with verification identification information when the user identification information is newly stored in a database in which information of the plurality of users is stored, the verification identification information being used for identifying the users and different from the user identification information, by executing any of a plurality of individual programs, acquires, from the database, the verification identification information associated with the user identification information when requesting a connection to the database based on the user identification information by executing any of the plurality of individual programs, adds the verification identification information to a record including the user identification information after assigning the verification identification information to the record when adding the record including the user identification information to the database after being connected to the database based on the user identification information, and manipulates the record including the user identification information stored in the database on the basis of (i) the verification identification information acquired from the database and (ii) the verification identification information associated with the record including the user identification information in the database when manipulating the record including the user identification information stored in the database by executing any of the plurality of individual programs after being connected to the database based on the user identification information.

A storage medium according to the third embodiment of the present disclosure is a non-transitory storage medium storing a common program called by a plurality of individual programs wherein the common program causes a processor to execute the steps of: storing user identification information for identifying a plurality of users in association with verification identification information when the user identification information is newly stored in a database in which information of the plurality of users is stored, the verification identification information being used for identifying the users and different from the user identification information, by executing any of a plurality of individual programs; acquiring, from the database, the verification identification information associated with the user identification information when requesting a connection to the database based on the user identification information by executing any of the plurality of individual programs; adding the verification identification information to a record including the user identification information after assigning the verification identification information to the record when adding the record including the user identification information to the database by executing any of the plurality of individual programs after being connected to the database based on the user identification information; and manipulating the record including the user identification information stored in the database on the basis of (i) the verification identification information acquired from the database and (ii) the verification identification information associated with the record including the user identification information in the database when manipulating the record including the user identification information stored in the database by executing any of the plurality of individual programs after being connected to the database based on the user identification information.

### BRIEF DESCRIPTION OF THE DRAWINGS

FIG. 1 is a diagram showing an outline of a business system according to the present embodiment.

FIG. 2 is a diagram showing a configuration of a server according to the present embodiment.

FIG. 3 is a diagram showing an example of a login user table according to the present embodiment.

FIG. 4 shows an example of a customer master table according to the present embodiment.

FIG. 5 shows an example of a product master table according to the present embodiment.

FIG. 6 shows an example of a product detail master table according to the present embodiment.

FIG. 7 illustrates an example in which a record that does not include a verification identification (ID) acquired by an acquisition unit according to the present embodiment is discarded.

### DETAILED DESCRIPTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### [Outline of a Business System S]

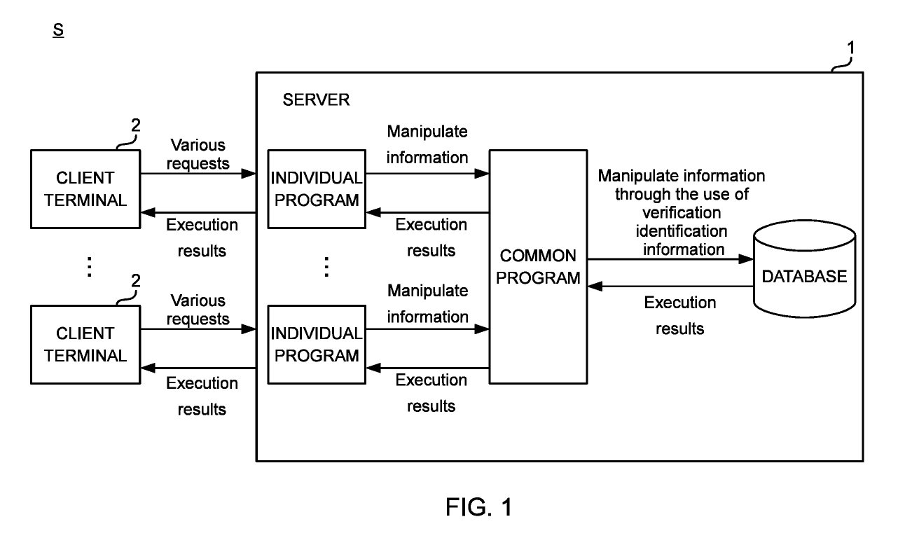

FIG. 1 is a diagram showing an outline of a business system S according to the present embodiment. The business system S is a system that includes a server 1 and a plurality of client terminals 2 capable of communicating with the server 1.

The server 1 realizes various functions of the business system S. The server 1 is operated by a service provider that provides the business system S. The client terminals 2 are computers used by customers (hereinafter, referred to as users) who use the business system S, and are a personal computer, a smart phone, and the like.

The server 1 accepts, from each of the plurality of client terminals 2, a request for displaying various types of information on the client terminals 2 or adding various types of information to the server 1. The server 1 executes individual programs in response to various requests. The server 1 includes a database that stores user information corresponding to each of the plurality of client terminals 2, and functions as a database management apparatus.

Each table stored in the database stores a user ID, serving as user identification information, for identifying the users of the client terminals 2. In addition, each table stores a verification ID, serving as verification identification information, in order to prevent erroneously manipulating information of other users.

When connecting to the database, the individual program designates login information corresponding to the users of the client terminals 2 and calls a common program. The common program performs authentication on the basis of the login information, and when the authentication succeeds, the common program acquires the verification ID associated with the user ID. The individual program calls the common program if the manipulation of the information stored in the database is performed after being connected to the database. The common program manipulates only the information corresponding to (i) the user ID based on the verification ID acquired at the time of connecting to the database and (ii) the verification ID included in the information to be manipulated, and returns the execution results to the individual program. By doing this, the common program can prevent manipulating the information of other users.

The individual program outputs execution results corresponding to various requests to the client terminals 2 based on the execution results returned by the common program. In the business system S, since the individual program manipulates the information of the users stored in the database via the common program that does not manipulate the information of other users, the business system S can prevent manipulation of the information of other users even if there is a failure in the individual program.

### [Configuration of the Server 1]

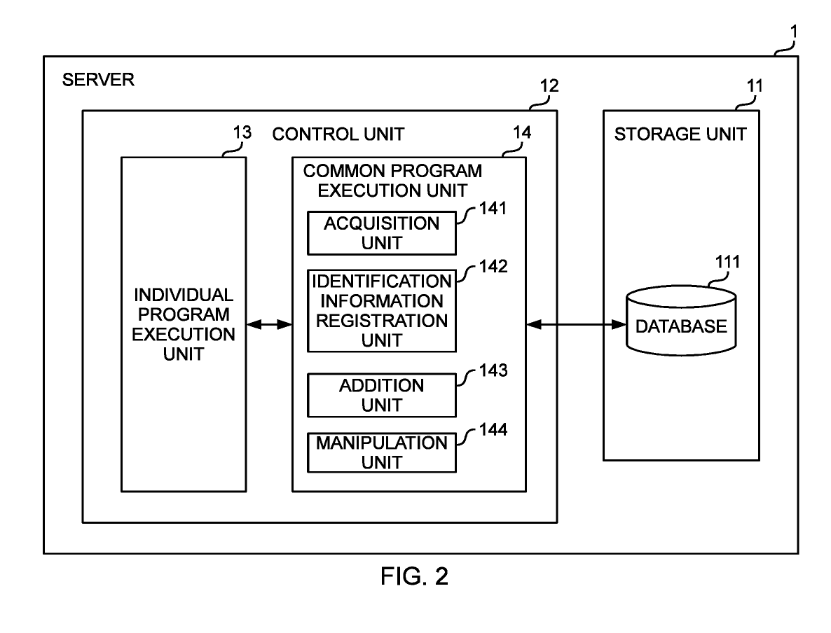

Next, the configuration of the server 1 will be described. FIG. 2 is a diagram showing a configuration of the server 1 according to the present embodiment.

The server 1 includes a storage unit 11 and a control unit 12. The storage unit 11 is, for example, a storage medium such as a ROM, a RAM, a hard disk, or the like. The storage unit 11 may have a non-transitory tangible recording medium that stores a program to be executed by the control unit 12. For example, the storage unit 11 stores a plurality of individual programs for realizing the respective functions of the business system S. The storage unit 11 also stores a common program that causes the control unit 12 to function as an acquisition unit 141, an identification information registration unit 142, an addition unit 143, and a manipulation unit 144. The common program includes a database engine that manages a database 111 storing information corresponding to the respective users of the client terminals 2.

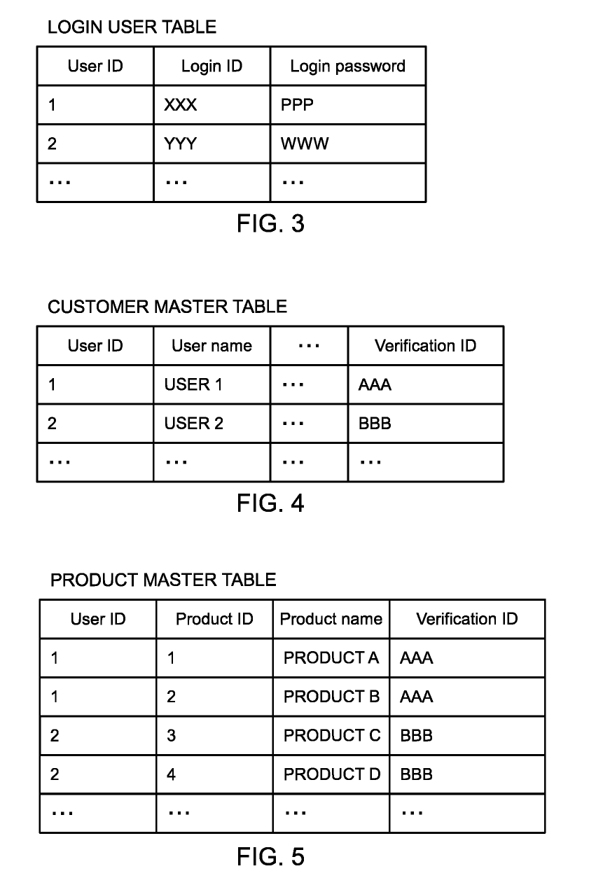

The database 111 stores, for example, a login user table, a customer master table, a product master table, and a product detail master table. FIG. 3 is a diagram showing an example of the login user table according to the present embodiment. As shown in FIG. 3, the login user table stores a user ID for identifying the users of the client terminals 2, a login ID used when connecting to the database 111, and a password corresponding to the login ID in association with each other. The user ID, the login ID, and the login password are, for example, generated by the service provider of the business system S and stored in the login user table.

FIG. 4 shows an example of the customer master table according to the present embodiment. As shown in FIG. 4, the customer master table stores the user ID, a user name, and the verification ID used by the common program in association with each other. Here, the verification ID is identification information for identifying the users of the client terminals 2 similarly to the user ID, but is identification information different from the user ID.

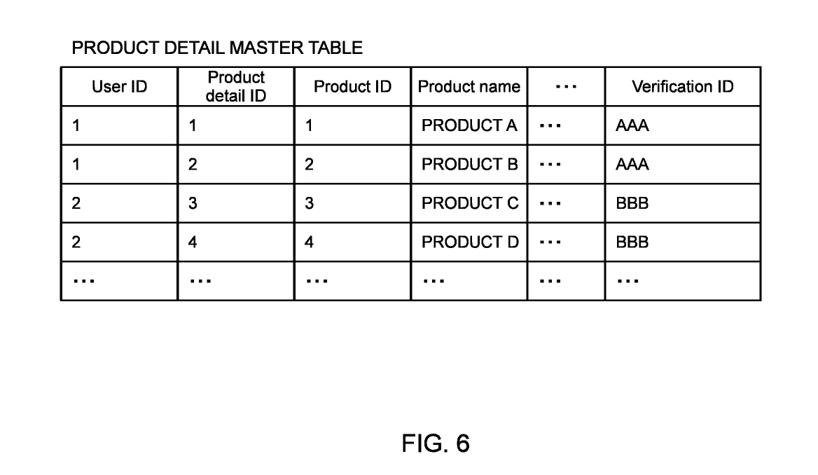

FIG. 5 shows an example of the product master table according to the present embodiment. As shown in FIG. 5, the product master table stores the user ID, a product ID for identifying a product, a product name, and the verification ID in association with each other. FIG. 6 shows an example of the product detail master table according to the present embodiment. As shown in FIG. 6, the product detail master table stores the user ID, a product detail ID for identifying a product having the same product ID based on the details of the product (for example, a color of the product), the product ID, the product name, and the verification ID in association with each other.

The control unit 12 is, for example, a CPU. The control unit 12 controls functions relating to the server 1 by executing various programs stored in the storage unit 11 or programs acquired from an external device via a communication network. The control unit 12 includes an individual program execution unit 13 that executes the individual program and a common program execution unit 14 that executes the common program.

The individual program execution unit 13 executes the individual program corresponding to each of the various requests in response to accepting the various requests from the client terminals 2. The individual program is, for example, a program constructed by the service provider of the business system S. The individual program is constructed to call the common program when accessing the database 111.

The common program execution unit 14 executes the common program in response to a common program being called in the plurality of individual programs. The common program execution unit 14 functions as the acquisition unit 141, the identification information registration unit 142, the addition unit 143, and the manipulation unit 144 by executing the common program.

When any of the plurality of individual programs requests a connection to the database 111 based on the user ID, the acquisition unit 141 acquires the verification ID associated with the user ID. When any of the plurality of individual programs requests a connection to the database 111 based on the login information associated with the user ID, the acquisition unit 141 acquires the verification ID associated with the user ID.

Specifically, first, any of the plurality of individual programs calls a common program by specifying the login ID and the login password, thereby requesting a connection to the database 111. When the specified login ID and the specified login password match the login ID and the login password stored in the login user table, the acquisition unit 141 permits access to the database 111 from the individual program that has requested the connection to the database 111. Here, a state in which access from the individual program to the database 111 is permitted is referred to as a state in which the individual program is connected to the database 111.

When the individual program is connected to the database 111, the acquisition unit 141 specifies the user ID associated with the specified login ID in the login user table. The acquisition unit 141 acquires the verification ID associated with the specified user ID in the customer master table. The acquisition unit 141 temporarily stores the acquired verification ID, as session information, in the storage unit 11. If the specified user ID does not exist in the customer master table, the acquisition unit 141 does not store the verification ID as the session information.

When any of the plurality of individual programs newly stores the user ID in the database 111, the identification information registration unit 142 stores the user ID in association with the verification ID. Specifically, the identification information registration unit 142 generates a verification ID when any of the plurality of individual programs newly stores a record that includes the user ID and the user name in the customer master table. Then, the identification information registration unit 142 stores the record that includes the user ID, the user name, and the verification ID in the customer master table.

Here, a function of the identification information registration unit 142 is realized by a security policy or a trigger of a database engine set for the customer master table. By doing this, the user ID and the verification ID can be reliably stored when the user ID is stored in the customer master table, because the function of the identification information registration unit 142 is always executed when the individual program adds the record to the customer master table.

In the present embodiment, information including the user ID is stored in the login user table and the customer master table at different timings, but the present disclosure is not limited to this. For example, information including the user ID may be stored in the login user table and the customer master table at the same timing by a series of processes, for example.

When any of the plurality of individual programs adds a record that includes the user ID to the database 111 after being connected to the database 111 based on the user ID, the addition unit 143 adds the record to the database 111 after assigning the verification ID acquired by the acquisition unit 141 to the record. Specifically, when a record that includes the user ID is added to a table different from the login user table and the customer master table among a plurality of tables stored in the database 111, the addition unit 143 assigns, as the session information, a verification ID temporarily stored in the storage unit 11 to the record. The addition unit 143 stores the record that includes the user ID and the verification ID in the table. In the present embodiment, when adding a record that includes the user ID to the product master table and the product detail master table, the verification ID is assigned to the record and the record with the verification ID is added to the product master table and the product detail master table.

Here, when adding the record that includes the user ID to the table stored in the database 111, the addition unit 143 outputs error information without adding the record that includes the user ID if the verification ID is not acquired by the acquisition unit 141. For example, the addition unit 143 outputs an execution result including error information indicating that the verification ID was not acquired to an individual program that has called a common program to add a record to the table stored in the database 111. By doing this, it is possible to notify the individual program side that the verification ID has not been acquired.

The function of the addition unit 143 is realized by the security policy or the trigger of the database engine set for the table including the user ID. In this manner, when the individual program adds the record to the table in which the security policy or the trigger corresponding to the function of the addition unit 143 is set, the function of the addition unit 143 is always executed, and therefore the verification ID can also be reliably stored when the user ID is stored in the table.

When any of the plurality of individual programs manipulates the information including the user ID stored in the database 111 after being connected to the database 111 based on the user ID, the manipulation unit 144 manipulates the information based on (i) the verification ID acquired by the acquisition unit 141 and (ii) the verification ID associated with the information. Here, it is assumed that the manipulation of information includes a selection manipulation of selecting information from the table, an update manipulation of updating information stored in the table, and a delete manipulation of deleting the record stored in the table.

Specifically, when selecting the record that includes the user ID from the table stored in the database 111, the manipulation unit 144 selects the information including the verification ID acquired by the acquisition unit 141. Specifically, the manipulation unit 144 selects the record that includes the user ID from the table stored in the database 111. Thereafter, the manipulation unit 144 discards the record that does not include the verification ID acquired by the acquisition unit 141 from the selected records. The manipulation unit 144 outputs, as the execution result, the information including the records that were not discarded to the individual program.

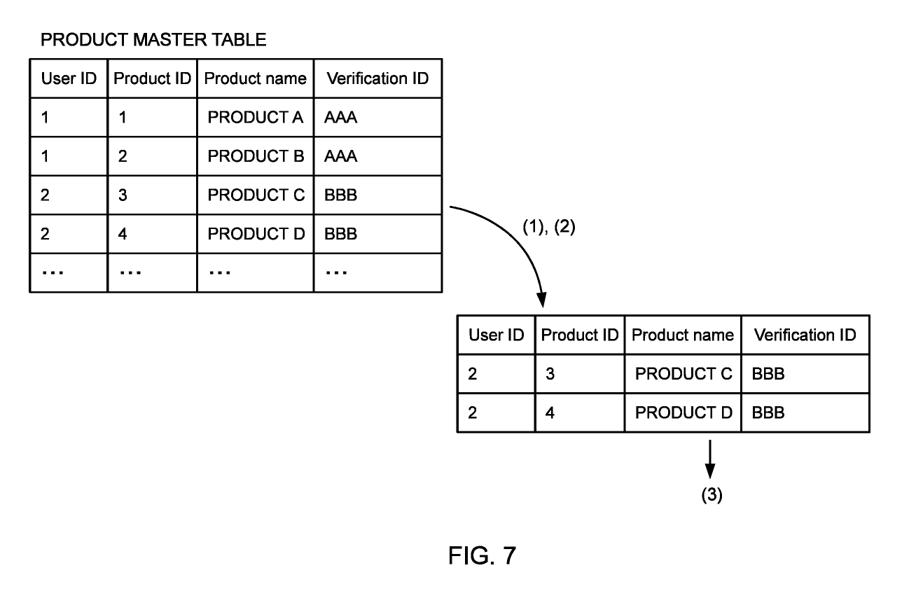

FIG. 7 illustrates an example in which a record that does not include the verification ID acquired by the acquisition unit 141 is discarded. For example, suppose that the individual program connects to the database 111 with the login information corresponding to the user ID “1”, and the acquisition unit 141 acquires the verification ID “AAA” corresponding to the user ID “1” ((1) in FIG. 7). Further, in the individual program, when the data of the user ID “1” is selected from the product master table shown in FIG. 7, where the user ID “1” should be set as the selection condition, suppose that the value of the product ID is erroneously designated as the value of the user ID and the product ID is “2”. In this case, the manipulation unit 144 selects the record of the user ID “2” ((2) in FIG. 7). Since the verification ID included in the record of the user ID “2” is “BBB” and the verification ID “AAA” acquired by the acquisition unit 141 is not included, the manipulation unit 144 discards the selected record ((3) in FIG. 7).

In this manner, the server 1 can prevent records corresponding to different user IDs from being output to the individual programs. In addition, because the manipulation unit 144 discards the record that does not include the verification ID acquired by the acquisition unit 141 after selecting the records that include the user ID, the information including the verification ID acquired by the acquisition unit 141 can be selected at a high speed when the user ID is indexed.

Also, when updating the record that includes the user ID in the table stored in the database 111, the manipulation unit 144 updates the record and outputs, as the execution result, information indicating that the record was updated to the individual program if the verification ID included in the record matches the verification ID obtain by the acquisition unit 141.

Also, when updating the record that includes the user ID in the table stored in the database 111, the manipulation unit 144 outputs the error information without updating the record if the verification ID included in the record does not match the verification ID acquired by the acquisition unit 141. The manipulation unit 144 outputs, as the execution result, information indicating that the record was not updated to the individual program.

Also, when deleting the record that includes the user ID in the table stored in the database 111, the manipulation unit 144 deletes the record and outputs, as the execution result, information indicating that the record was deleted to the individual program if the verification ID included in the record matches the verification ID acquired by the acquisition unit 141.

Also, when deleting the record that includes the user ID in the table stored in the database 111, the manipulation unit 144 outputs the error information without deleting the record if the verification ID included in the record does not match the verification ID acquired by the acquisition unit 141. The manipulation unit 144 outputs, as the execution result, information indicating that the record was deleted to the individual program.

It should be noted that the function of the manipulation unit 144 is realized by the security policy or the trigger of the database engine set for the table including the user ID. In this manner, when the individual program manipulates (selects, updates, or deletes) the table in which the security policy or the trigger corresponding to the function of the manipulation unit 144 is set, the function of the manipulation unit 144 is always executed, and therefore it is possible to reliably prevent the manipulation of information of other users.

As described above, by executing the common program, the server 1 according to the present embodiment (i) acquires the verification ID associated with the user ID when any of the plurality of individual programs requests a connection to the database 111 based on the user ID, (ii) adds information to the database 111 after assigning the acquired verification ID to the information when any of the plurality of individual programs adds the information including the user ID to the database 111 after being connected to the database 111 based on the user ID, and (iii) manipulates the information based on the acquired verification ID and the verification ID associated with the information when any of the plurality of individual programs manipulates the information including the user ID stored in the database 111 after being connected to the database 111 based on the user ID. In this manner, the server 1 can prevent the information from being manipulated when the acquired verification ID does not match the verification ID associated with the information. Accordingly, the server 1 can prevent manipulation of the information of other users.

The present disclosure has been described above on the basis of the exemplary embodiments. The technical scope of the present disclosure is not limited to the scope explained in the above embodiments, and it is obvious to those skilled in the art that various changes and modifications within the scope of the disclosure may be made. An embodiment to which such changes and modifications are added can be included in the technical scope of the present disclosure is obvious from the description of the claims.

What is claimed is:

1. A database management method, executed by a processor, comprising steps of:
storing user identification information for identifying a plurality of users in association with verification identification information when the user identification information is newly stored in a database in which information of the plurality of users is stored, the verification identification information being used for identifying the users and different from the user identification information, by executing any of a plurality of individual programs;
acquiring, from the database, the verification identification information associated with the user identification information when the processor requests a connection to the database based on the user identification information by executing any of the plurality of individual programs;
adding the verification identification information to a record including the user identification information after assigning the verification identification information to the record when the processor adds the record including the user identification information to the database by executing any of the plurality of individual programs after being connected to the database based on the user identification information; and
manipulating the record including the user identification information stored in the database on the basis of (i) the verification identification information acquired from the database and (ii) the verification identification information associated with the record including the user identification information in the database when the processor manipulates the record including the user identification information stored in the database by executing any of the plurality of individual programs after being connected to the database based on the user identification information.

2. The database management method according to claim 1, wherein the method further comprises
acquiring the verification identification information associated with the user identification information when the processor requests a connection to the database based on login information associated with the user identification information by executing any of the plurality of individual programs.

3. The database management method according to claim 1, wherein the method further comprises
selecting a record including the verification identification information associated with the user identification information from among a plurality of records including the user identification information being selected from the database when the processor manipulates the record including the user identification information in the database.

4. The database management method according to claim 3, wherein the processor discards a record not including the verification identification information from the selected record after selecting the record including the user identification information from the database.

5. The database management method according to claim 1, wherein the processor outputs error information without updating the record when updating the record including the user identification information in the database if the verification identification information included in the record does not match the acquired verification identification information.

6. The database management method according to claim 1, wherein the processor outputs error information without deleting the record when deleting the record including the user identification information from the database if the verification identification information included in the record does not match with the acquired verification identification information.

7. The database management method according to claim 1, wherein the processor outputs error information without adding the record including the user identification information when adding the record including the user identification information to the database, if the verification identification information is not acquired.

8. A database management apparatus including:
a storage medium storing a database; and
a processor, wherein the processor
stores user identification information for identifying a plurality of users in association with verification identification information when the user identification information is newly stored in a database in which information of the plurality of users is stored, the verification identification information being used for identifying the users and different from the user identification information, by executing any of a plurality of individual programs,
acquires, from the database, the verification identification information associated with the user identification information when requesting a connection to the database based on the user identification information by executing any of the plurality of individual programs,
adds the verification identification information to a record including the user identification information after assigning the verification identification information to the record when adding the record including the user identification information to the database after being connected to the database based on the user identification information, and
manipulates the record including the user identification information stored in the database on the basis of (i) the verification identification information acquired from the database and (ii) the verification identification information associated with the record including the user identification information in the database when manipulating the record including the user identification information stored in the database by executing any of the plurality of individual programs after being connected to the database based on the user identification information.

9. A non-transitory storage medium storing a common program called by a plurality of individual programs wherein the common program causes a processor to execute the steps of:
storing user identification information for identifying a plurality of users in association with verification identification information when the user identification information is newly stored in a database in which information of the plurality of users is stored, the verification identification information being used for identifying the users and different from the user identification information, by executing any of a plurality of individual programs;
acquiring, from the database, the verification identification information associated with the user identification information when requesting a connection to the database based on the user identification information by executing any of the plurality of individual programs;
adding the verification identification information to a record including the user identification information after assigning the verification identification information to the record when adding the record including the user identification information to the database by executing any of the plurality of individual programs after being connected to the database based on the user identification information; and
manipulating the record including the user identification information stored in the database on the basis of (i) the verification identification information acquired from the database and (ii) the verification identification information associated with the record including the user identification information in the database when manipulating the record including the user identification information stored in the database by executing any of the plurality of individual programs after being connected to the database based on the user identification information.
